(19) United States
(12) Patent Application Publication
(10) Pub. No.: US 2026/0268247 A1
(43) Pub. Date: Sep. 10, 2026

(54) METHOD FOR DIGITAL PRODUCT LIFECYCLE AGILITY BLOCKAGE REDUCTION BALANCED ACROSS SPEED, QUALITY, AND COST

(71) Applicant: Michael Eric Idengren, Provencetown, MA (US)

(72) Inventor: Michael Eric Idengren, Provencetown, MA (US)

(21) Appl. No.: 19/070,015

(22) Filed: Mar. 4, 2025

(51) Int. Cl. G06Q 10/0631; G06Q 10/0635; G06Q 40/06

(52) U.S. Cl. CPC G06Q 10/06313; G06Q 10/0635; G06Q 40/06

(57) ABSTRACT

A method for reducing digital product lifecycle agility blockage across speed, quality, and cost is disclosed. The invention provides an automated approach for analyzing symptoms, tracking real-time agility metrics, and guiding investment decisions to optimize digital product development cycles.

### TECHNICAL FIELD

The present invention relates to a novel approach for measuring, analyzing and improving causes of poor scaled agility when bringing products/services to market, and more particularly to balancing and improving speed, quality and cost by implementing digital business transformation-related capabilities (e.g., Enterprise Architecture, DevOps, and Application Portfolio Management/Rationalization). Further, the invention relates to methods and systems for improving digital product lifecycle agility by reducing blockages that affect speed, quality, and cost. The invention provides a structured approach for defining, allocating, and improving capability targets in agile product development environments.

### BACKGROUND

Since the early days of “agility” (~2000-2010) in the field of software development, developers and project managers have endeavored to rapidly build and deliver software in chunks of features and functionality through iterative and incremental development (e.g., using Scrum/XP practices). Improving agility meant having better capabilities to respond quickly to market changes, for example, development processes that emphasized lightweight requirements (e.g., customer-centric “user stories” instead of heavy up-front requirements), rapid prototyping, and Software Development Lifecycle (SDLC) tool automation. The agile manifesto was born, and its principles continue to guide software development practices to this day.

As the software development industry became more experienced in developing agile software solutions, larger organizations started taking notice, wanting to deliver (and maintain/operate) products and services with better agility. Around this time (~2010), complete frameworks (e.g., SAFe®/2011, LeSS/2013) and organizational models (Spotify/2012) started becoming available to help guide complex digital business transformation (DBT) efforts to become more agile “at scale”. There was a realization that necessary capabilities went beyond software development automation and Scrum/XP practices, for example by bringing in more timely viewpoints of product development/marketing, quality assurance (QA), project portfolio management (PPM), organizational change management (OCM), and Information Technology (IT). In short, more stakeholders needed to participate for the development, quality, stability, and economic sustainability of the product's entire lifecycle.

To help organizations achieve better scaled agility from these collective viewpoints, they need to improve certain capabilities. Frequently, many start with the typical software development agility capabilities, such as DevOps automation (e.g., code check-in, triggering automated unit testing). Other non-technical capabilities are also necessary, such as Business Process Management (BPM) and Lean Portfolio Management (LPM)—to help improve budgeting and better investment-to-market alignment and IT, capability improvements, such as application portfolio lifecycle management and lean enterprise technology governance.

To help organizations improve such capabilities needed for scaled agility, consulting firms and software vendors have brought capability improvement models (typically CMMI-based) to help understand organizational maturity in specific domains (e.g., “User Experience”, “DevOps”). They typically identify baseline maturity (e.g., on a scale from 1-5), set targets, and then sell products and services to help improve the desired capabilities.

The use of CMMI-based assessment as the foundational basis for agility improvement targets is inherently flawed. CMMI-based assessments are frequently tailored to focus on improvement within specific capability domains, frequently without understanding the underlying root causes. Furthermore, CMMI encourages focus on measurement at maturity level 4, when in reality, most organizations still operate at level 3 or lower.

Even when organizations do track metrics related to agility capability improvements, such metrics are the ones that are typically “easy to get” (i.e., those that consultancies and tool vendors can be held accountable for). For example, they might ask technical speed-related questions, such as “how fast is our DevOps code check-in and unit-test completion now, versus before the investment?” when the key question to ask is: “how fast can a product go from idea to a quality-assured, economically viable release?” Typically, data needed to answer the key question is not easy (or reliable) to collect. In such, organizations will tend to “pull a lever” (i.e., choose one with easily quantified metrics or “gut feel”) and hope that improves outcomes related to the key question.

A need exists for a novel approach to answer the key question, with respect to an organizations' strategic-context importance of speed vs. quality vs. cost effectiveness (since many organizations cannot put their focus everywhere at the same time). The “development lifecycle” needs more transparency, achieved through symptom data collection and analysis of root causes. A further need exists to incentivize capability owners to invest in making improvements that will focus on key outcomes and in turn, reduce lean-flow blockage. Finally, there is a need to provide more defensible justification for investment needed to fund capability improvements.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments consist of a novel method for analysis of data needed to identify and improve symptoms and root-causes of poor agility, especially in a scaled context where speed, quality, and cost must be balanced. Key symptoms are aligned to “capability plug-ins” needed to realize improvements (for example, “Design & Architecture” or “DevOps”). Symptoms are quantified as a “blockage index” to evaluate the severity of agility deficiency, and a holistic “improvement action plan” with metric-supported lean business case(s) are hypothesized to make improvements. Portions of symptom metrics are allocated to specific capabilities to incentivize capability owners to deliver the most important outcomes. Over discrete time periods, symptoms are re-quantified, and improvements are tracked using role-friendly visualizations, such as executive, project/product manager, and capability owner views.

The disclosed method for reducing digital product lifecycle agility blockage across speed, quality, and cost includes the various steps described below. An agile speed limit is set with respect to one or more product risk consequence failures and a dimension focus weight is set with respect to one or more business priorities. One or more symptoms and one or more symptom categories are defined, allocated, and reviewed. Next, the improvement of one or more capability targets is planned and one or more data collection assets are built and deployed. One or more blockage details are calculated per symptom category. Data collection is displayed in real-time to permit a user to view one or more objective progress tracking results and a capability investments case input is provided. One or more blockage improvements may then be provided and one or more object balance achievement dashboard.

The method includes setting an agile speed limit based on risk assessments, applying adaptive dimension focus weights, categorizing agility symptoms, implementing targeted capability enhancements, computing weighted blockage metrics, and providing AI-driven investment recommendations. Real-time analytics and predictive modeling enable organizations to track agility trends dynamically and benchmark against industry-specific performance baselines.

The system utilizes a processor, real-time tracking modules, and AI-powered recommendation engines to support decision-making. The method is embodied in a non-transitory computer-readable medium, where AI-driven algorithms facilitate symptom analysis and investment case generation. The invention ensures agility improvement by dynamically refining blockage trends and enabling data-driven resource allocation.

In one aspect, the agile speed limit determines a weighting mix of a cost, a quality, and a speed of a product's development.

In one aspect, the one or more business priorities includes one or more external factors.

In one aspect, the one or more external factors include considerations beyond a specific product.

In one aspect, the one or more symptoms include objective and quantifiable data collection criteria.

In one aspect, the quantifiable data criteria include unfavorable affect speed, quality, or cost.

In one aspect, the one or more capability targets include one or more relevant improvements to the product's development, or one or more program management techniques expected to make a quantified reduction to one or more key symptom indicators.

In one aspect, the one or more key symptom indicators include symptom metrics summarized from one or more data collection activities.

In one aspect, the one or more objective progress tracking results include an overall objective achievement, an objective achievement detail, an overall blockage improvement, a dimension balance and blockage, and one or more blockage trends.

In one aspect, the capability investment business case input guides one or more funding decisions for specific capabilities.

In one aspect, the one or more funding decisions are based on an impact to the one or more key symptom indicators, a symptom impact, and a relative capability cost.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a schematic of a process and role flowchart that exemplifies the application of the invention in context of key stakeholders, according to some embodiments;

FIG. 2 illustrates a block diagram wherein the logical flow of user interfaces that are relevant in context of the process and key stakeholders, according to some embodiments;

FIG. 3 illustrates a schematic including the balance of dimension focus weight, which will be important context, according to some embodiments;

FIG. 4 illustrates a schematic including the concept of an “Agile Speed Limit”, limiting the speed weighting with respect to quality or quality/cost, according to some embodiments;

FIG. 5 illustrates a schematic wherein the agile speed limit is calculated, with specific formula references and an exemplary visualization of a user interface to select and confirm settings, according to some embodiments;

FIG. 6 illustrates a block diagram including the concept of applying speed limit focus, which will be important for scope selection, according to some embodiments;

FIG. 7 illustrates a schematic including the dimension focus weight calculations, with specific formula references and an exemplary visualization of a user interface to select and confirm weights, according to some embodiments;

FIG. 8 illustrates a schematic including symptom allocations to dimensions (speed, quality, cost) with specific formula references and an exemplary visualization of a user interface to select applicability, according to some embodiments;

FIG. 9 illustrates a schematic including the improvement plan & objective targets for a given period, with specific formula references and exemplary user interface showing KSI start & KSI target, according to some embodiments;

FIG. 10 illustrates a schematic including the data collection panel, with specific formula references and exemplary user interface to select scope, input/review data entry, according to some embodiments;

FIG. 11 illustrates a schematic including the objective progress tracking, with specific formula references and exemplary user interface to display scope, period, context, summary plan & objectives, target, and actual metrics, according to some embodiments;

FIG. 12 illustrates a schematic including blockage in context of symptoms or symptom categories, with specific formula references and exemplary user interface to display scope, period, summary plan, start, target, and actual blockage (per symptom or symptom category), according to some embodiments;

FIG. 13 illustrates a schematic including a high-level executive view of overall weighted blockage improvement given a selected scope and period, according to some embodiments;

FIG. 14 illustrates a schematic including the absolute (non-weighted) change in Key Symptom Indicators over time, according to some embodiments;

FIG. 15 illustrates a schematic including a high-level executive view of overall objective achievement, using non-weighted Key Symptom Indicators, according to some embodiments;

FIG. 16 illustrates a schematic including blockage change in terms of target weight balance set for the relevant period per dimension (speed, quality, cost), according to some embodiments;

FIG. 17 illustrates a schematic including the three-dimensional method for determining relative capability investment scores, considering capability cost, capability impact on symptoms, and symptom weight, according to some embodiments;

FIG. 18 illustrates a block diagram including relevant system components of the system and interaction with end users, according to some embodiments;

FIG. 19 illustrates a block diagram of the processing of data by a computer system (cloud, server, or client), according to some embodiments;

FIG. 20A illustrates a flowchart of a method for reducing digital product lifecycle agility blockage across speed, quality, and cost, according to some embodiments; and

FIG. 20B illustrates a flowchart of a method for reducing digital product lifecycle agility blockage across speed, quality, and cost, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

The invention comprises a novel method for analysis of data needed to identify and improve symptoms and root-causes of poor agility, especially in a scaled context wherein speed, quality, and cost must be balanced. Key symptoms are aligned to “capability plug-ins” needed to realize improvements (for example, “Design & Architecture” or “DevOps”). Symptoms are quantified as a “blockage index” to evaluate the severity of agility deficiency, and a holistic “improvement action plan” with metric-supported lean business case(s) are hypothesized to make improvements. Portions of symptom metrics are allocated to specific capabilities to incentivize capability owners to deliver the most important outcomes. Over discrete time periods, symptoms are re-quantified, and improvements are tracked using role-friendly visualizations, such as executive, project/product manager, and capability owner views.

### Process Overview

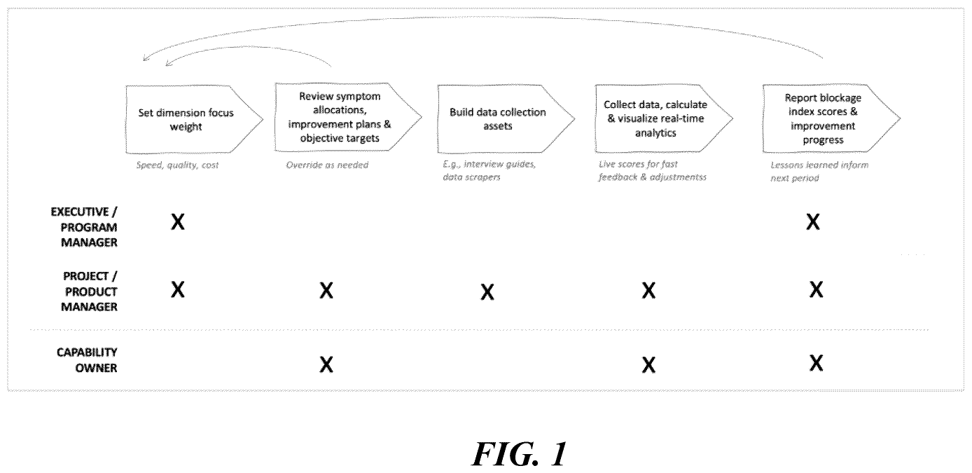

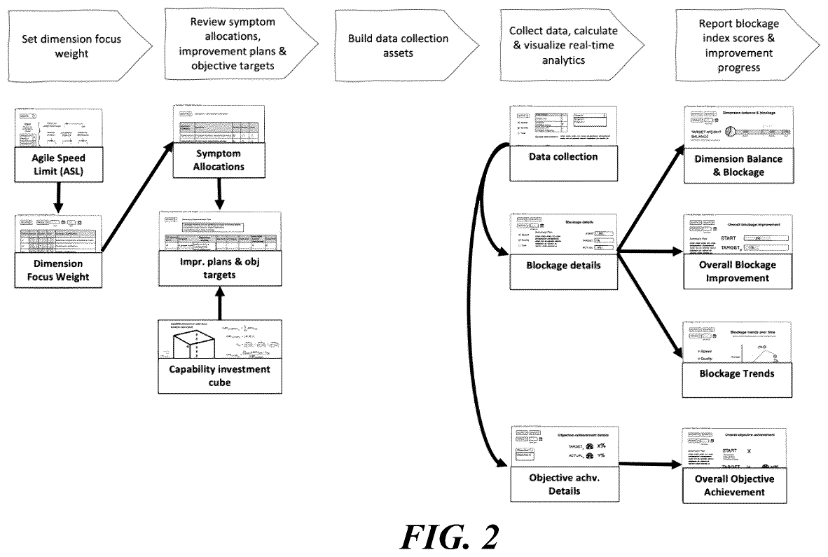

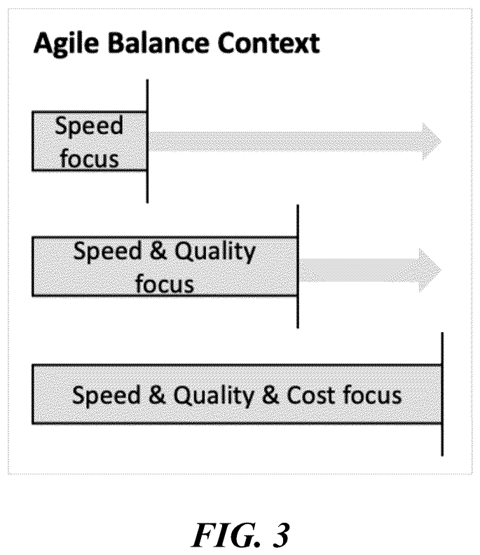

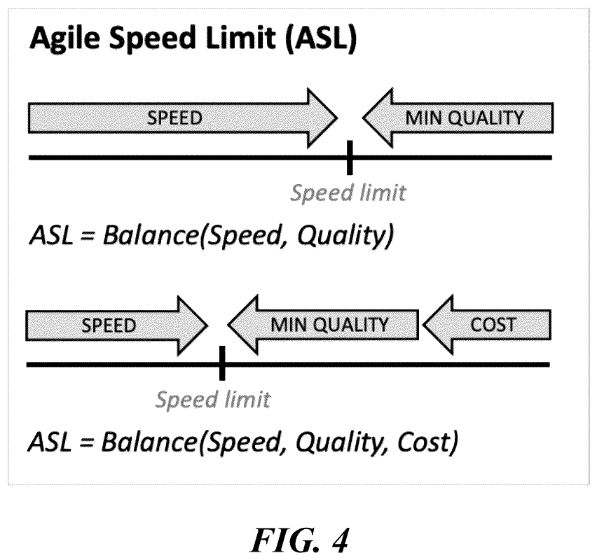

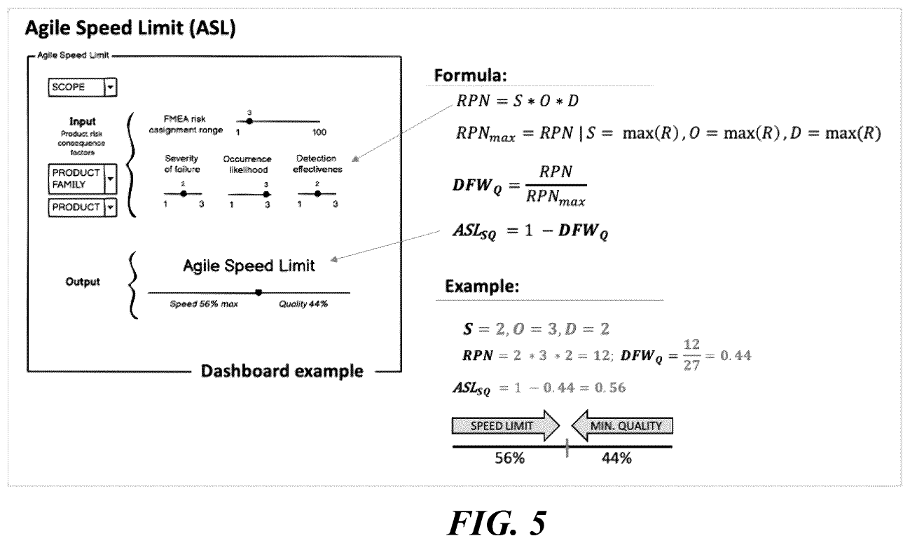

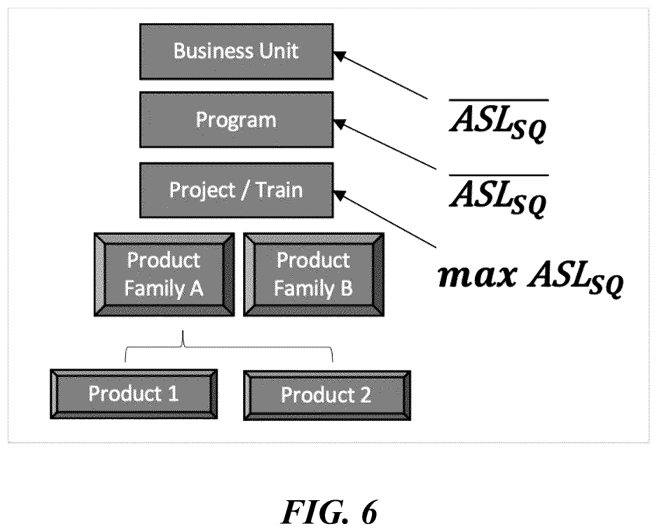

For any organization, the objective of agility is to maximize speed-to-market without sacrificing quality that is economically feasible (i.e., a reasonable cost). The embodiments illustrates process and roles (see FIG. 1), user interface flow (see FIG. 2) in temporal strategic context, Agile Balance Context (see FIG. 3), Agile Speed Limit (ASL) (see FIG. 4), ASL calculation (see FIG. 5), ASL context for reducing agile blockage wherein agility is balanced across three dimensions, wherein the three dimensions including speed, agility, and cost (see FIG. 6).

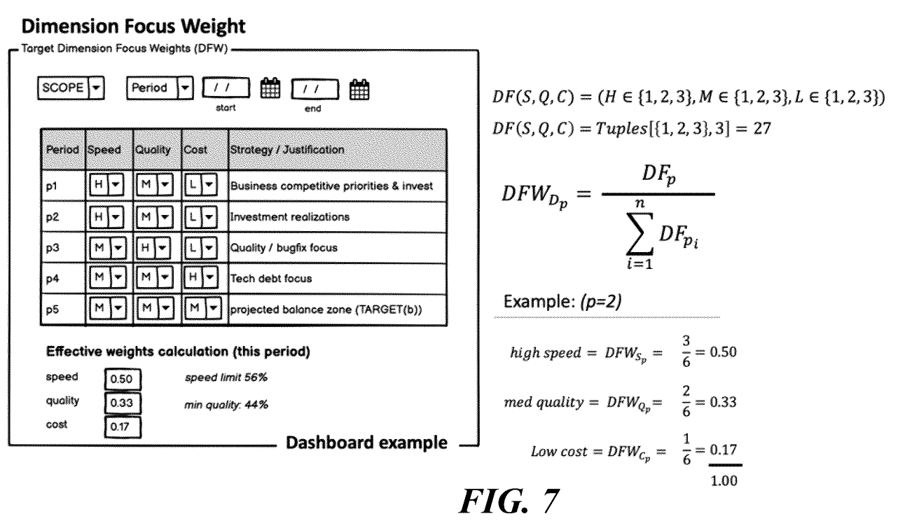

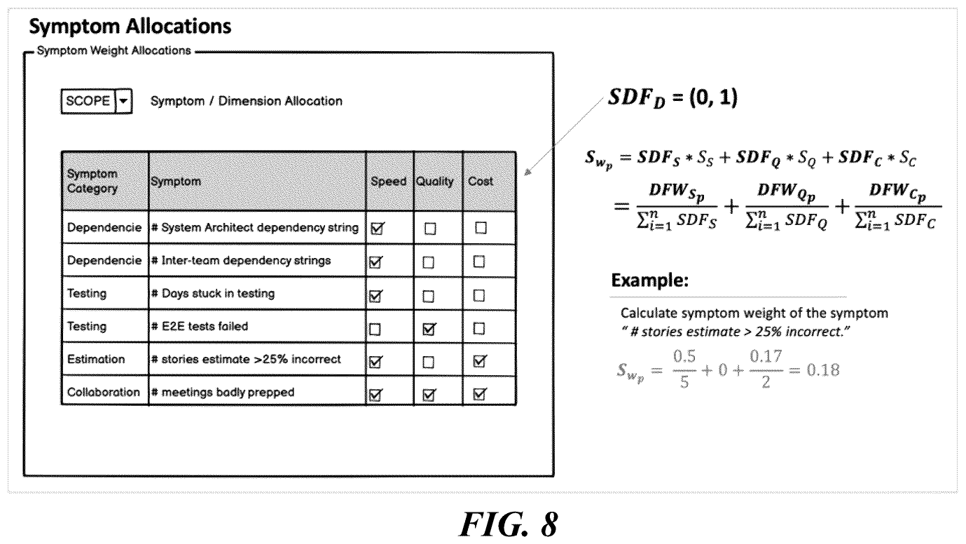

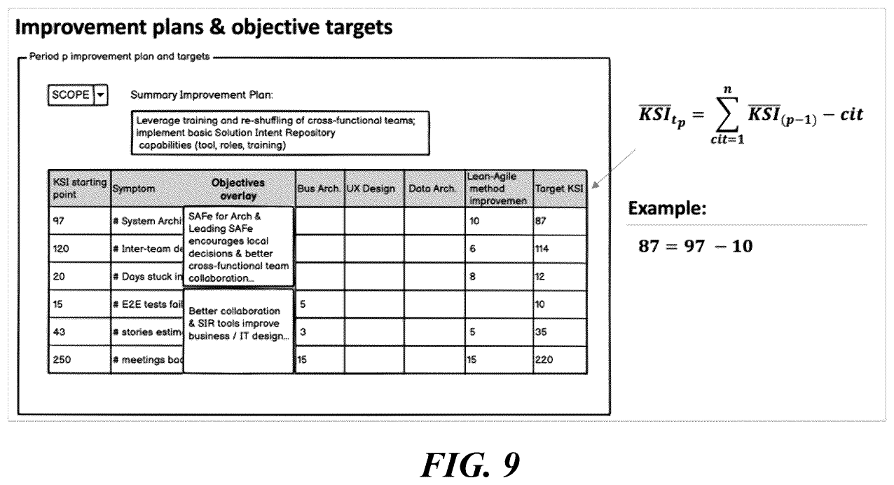

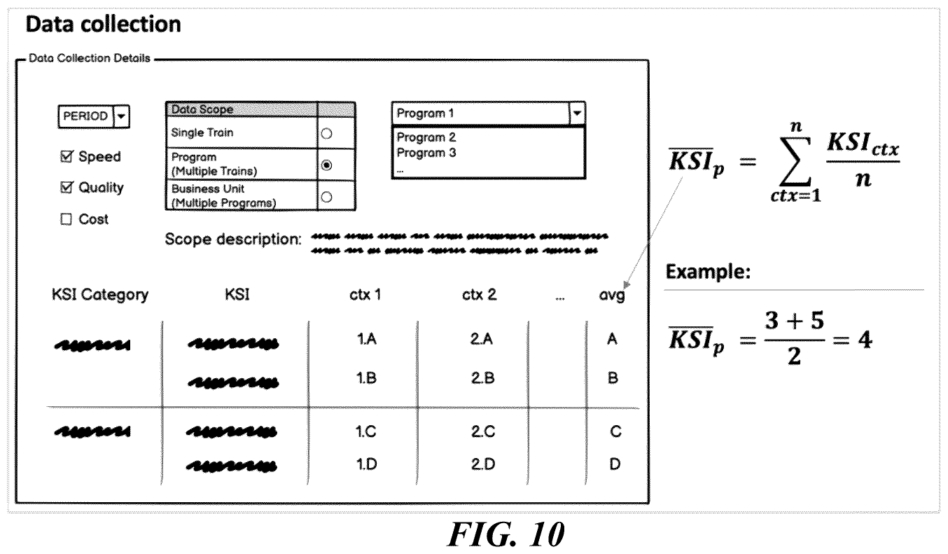

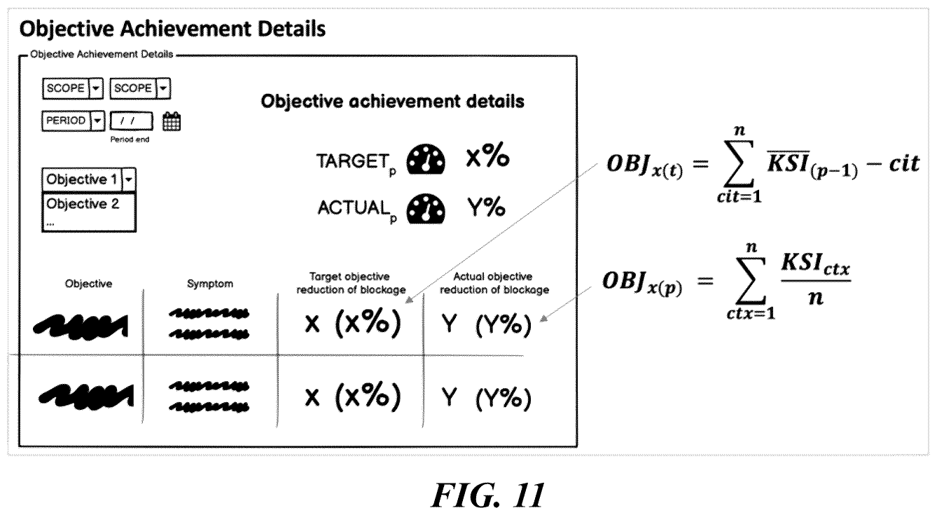

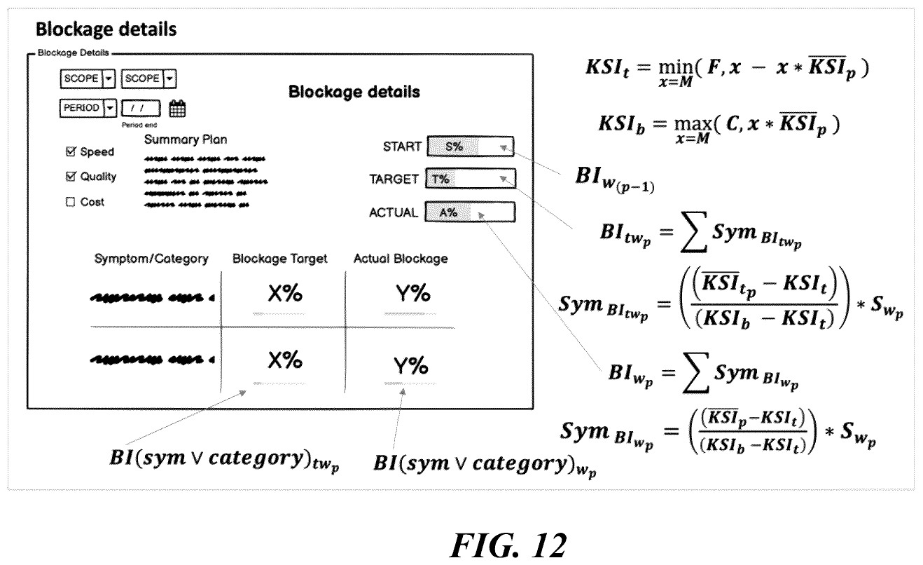

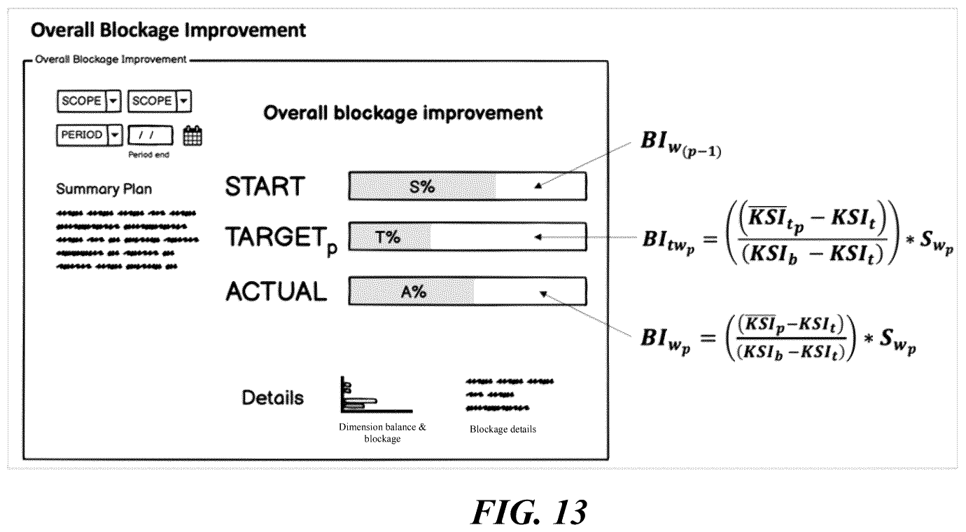

In the first step of the process, Dimension Focus Weight (DFW) is set, taking into consideration both product needs and organization's external focus factors as show in FIG. 7. In step two, the symptoms are defined and reviewed, and plans are made to improve capabilities which will set specific targets to reduce symptoms, resulting in a lower “Key Symptom Indicator”, and in turn, a lower blockage index (see FIG. 8 and FIG. 9). Steps one and two are repeated until key stakeholders are satisfied that dimension weights, realistic symptoms/allocations, improvement plans, and targets are set. In step three, data collection assets are built and deployed (e.g., interview guides, system data scraper programs), or data is collected manually with a user interface and data input fields (see FIG. 10). In step four, data collection progress is displayed live (see FIG. 11 and FIG. 12), allowing capability owners and project/product managers to view live objective progress tracking results. Capability owners can make quick adjustments to capability implementations to meet their capability-specific target symptom reduction commitments (see FIG. 11). Product/project managers can view up-to-date blockage progress results—focusing on the reduction of symptoms, regardless of capability (see FIG. 12). Finally, overall high-level blockage improvement and objective balance achievement dashboards can be shown with simple “roll-up” metrics for executive-level communication (see FIGS. 13-16).

In some embodiments, when considering an objective and related KSI impacts, capability owner and key stakeholders will judge Max possible improvement (rarely would any improvement beyond 80% yield optimal results because of diminishing marginal returns). This can vary based on subject area. The system may not attempt to improve System Architect dependency strings beyond 50% improvement. Factors are defined (col F) across tech, people and process; such factors are classified as “drivers” (demanding improvement) or constraints (realizing improvements will be limited), and in some contexts, a High/Medium/Low score is assessed. The resulting guide target (“Realistic improvement next period”) in col E is calculated according to formula in col G.

### Step 1: Set Dimension Focus Weight

In summary, the ASL (Agile Speed Limit) and DFW (Dimension Focus Weight) are codified to acknowledge strategic conditions which will incentivize importance on improving some symptoms rather than others (e.g., a high focus on technical debt can help justify application/technology portfolio rationalization and management capabilities, to improve relevant symptoms).

In further reference to the first step of the process, dimension focus weights is set across speed, quality, and cost (see FIG. 7). The three dimension focus weights together sum up to 100 percent. The focus of an organization cannot be everywhere at once, and there must be acknowledgement of temporal internal and external drivers that will affect the balance of focus, known as the “Agile Balance Context”.

FIGS. 3-6 illustrate the concept of a maximum weighting for speed known as “ASL” Agile Speed Limit. The embodiments are elaborated in the context of agility, where speed-to-market is the typical dominant focus. Therefore, speed is a function of quality and cost.

In some embodiments, the Agile Speed Limit is balanced with respect to Speed and Quality (ASLSQ) wherein the minimum required product/product family quality level acts as a displacement constraint on speed. Quality is fixed to a required percentage of weight consideration, and speed is weighted “whatever is remaining”. For example, in the context of a program where a NASA parts supplier produces O-rings for space shuttle solid rocket boosters, quality is driven by risk which is offset by life-saving non-functional design and engineering requirements. This necessarily creates inverse pressure on speed to ensure required quality before it is released, and cost becomes a tertiary concern.

In some embodiments, the Agile Speed Limit is balanced with respect to Speed, Quality and Cost (ASLSQC). Cost may be added as an additional dimensional constraint on speed but does not affect the minimum quality constraint. Accordingly, for all embodiments of the invention, it is required that the minimum quality level first be set with respect to speed (ASLSQ), with acknowledgement that product-specific quality/cost trade-offs can be made within the ASLSQ FMEA RPN calculations (further detailed in the next section). Continuing the previous NASA O-ring example, an organization that focuses on life-saving quality constraints will typically have lower cost weight constraints than an organization which is mass-producing commodities and needs more focus on cost-per-unit. In other examples, an organization may have high technical debt from previous investments or have a strong temporal influence from macroeconomic conditions (e.g., a pandemic constraining demand) and may want to introduce more cost focus (for a specific time period p).

ASL is determined by first calculating ASLSQ, regardless of cost weighting. This effectively makes ASLSQ a more quantitatively defensible portion of the ASL, with the optional ASLSQC cost portion being more subjective.

For ASLSQ to objectively set quality as a displacement of speed, there must be a reasonable method for approximating the weight of quality. FMEA (Failure Modes and Effects Analysis) is a convenient method for estimating the consequence of product failure. This is especially relevant because the focus of data collection is done with respect to symptoms (actual outcomes), with capability improvements being the means to reduce symptoms.

In a simple ASLSQ calculation embodiment, FMEA RPN (Risk Priority Number) is used as a proxy to approximate the weight of quality, where RPN for a given product/product family=Severity of failure S*Occurrence of likelihood O*Detection effectiveness D. There are various ways to calculate FMEA for a given product/product family, for example, providing more precision to how product subject matter experts judge dimensions of RPN (R-TOPSIS-AL). Additionally, a cost dimension can be added to RPN, but it should be noted that this would provide a product-cost restraint perspective, not including overall shared costs (e.g., efforts to reduce technical debt). Criteria for selection of the best-fit FMEA calculation method is outside the scope of this invention, but it is recommended that organizations avoid over-investment in FMEA calculation for the sole purpose of ASLSQ calculation.

ASL & Dimension Focus Weight Calculation. As shown in FIG. 5, the FMEA risk assignment range is first set (1-100), where higher range gives more precision to the RPN calculation. In the example embodiment shown, the range is set for 1-3 and RPN considers product/family severity of failure, occurrence likelihood, and detection effectiveness are set between 1-3.

$$R P N = 2 * 3 * 2 = 12$$

and the maximum RPN possible is

$$RPN max = 27$$

The Dimension Focus Weight for Quality is:

$$DF {W}_{{Q}_{p}} = ( 12 / 27 ) = 0.44 ( 44 \% )$$

Thus, ASLSQ cannot exceed 0.56 (56%).

In reference to FIG. 6, the Agile Speed Limit is considered in context of a project, or a Scaled Agile Framework for Enterprises (SAFe®) Agile Release Train (ART). In this embodiment, ASL is set in context of a product family (e.g., Product Family A), but could also be set in context of a specific Product. In a SAFe contextual embodiment, products or product families are developed, released, operated and maintained in the context of an ART (a long-lived team of Agile teams, along with other stakeholders, who incrementally develop, deliver, and where applicable operate, one or more solutions in a value stream). Although the nature of agile projects emphasize autonomy and localized decision making, larger and/or more complex projects will incorporate the use of common resources (e.g., system architects, business architects). Accordingly, the product/family with the lowest ASLSQ will constrain the speed of the project/train. In another embodiment, the ASL is viewed in a higher context, (e.g., program) and ASLSQ is “rolled up” as an average of the speed limit for all trains within the program.

When the maximum speed and minimum quality levels have been set, they become “guardrails” that help guide the final selection of target Dimension Focus Weight for dimensions in a specific period (DFW_{D}_{_{P}}). As shown in FIG. 7, the organization has the opportunity to make simple discrete selections (High, Medium, Low) for dimensions D (Speed, Quality, and Cost) for a given period p. Each period can have a different mix of dimension weightings based on relevant internal or external organizational conditions at the time (for example, macro/microeconomic conditions, competitive situation, or product lifecycle concerns).

The illustrated embodiment of dimension focus weight selection illustrated in FIG. 7 shows drop-down values that can be selected, with effective weights calculated and validated against minimum quality and maximum speed constraints. This interface exemplifies the intended design to ensure that weights add up to 100%, are reflective of relevant internal or external organizational conditions, and are guided by recommended constraints. For example, when selecting values “High, Medium and Low” for speed, quality and cost respectively, speed is assigned 0.5, quality is 0.33 and cost is 0.17. Quality is flagged with a warning that the recommended minimum is 44%, and a possible additional design variant of the dashboard can recommend adjustment to lower speed or cost, as needed to accommodate minimum quality.

### Step 2: Review Symptom Allocations, Improvement Plans & Objective Targets

The second step of the process is to select, tailor and review symptoms and applicable dimension allocations, improvement plans & objective targets. These activities are done together to validate Key Symptom Indicators (KSI's) are relevant for one or more dimensions (speed, quality, cost) and they are aligned to objectives that can help reduce blockage (i.e., reduce symptom impact).

Example symptoms are shown in FIG. 8. The embodiments may not prescribe specific line-item symptoms, and instead intends organizations and advisors to develop “KSI/Capability plug-ins” that are relevant for functional areas and business domains. For example, one embodiment of the symptom elaboration can be aligned to the Continuous Delivery Pipeline (CDP). In this embodiment, a company's detailed DevOps process is decomposed to understand where blockage occurs (evidenced by Key Symptom Indicators). An example embodiment of Capability plug-in “Design & Architecture” might discuss some of the symptoms indicated in FIG. 9, such as addressing system architect dependencies with relevant capabilities (e.g., Business Architecture, Data Architecture).

Symptoms may be hierarchically arranged in several layers, such that the highest is a “symptom category”, and lower levels are aggregated to support higher levels. A Key Symptom Indicator (KSI) is the applicable level for which metrics can be collected and rationalized against capabilities and dimensions (speed, quality, cost). Additionally, through a root-cause analysis exercise, KSIs can then be cross-correlated against common root causes. For example, testing issues and excessive system architecture strings (dependencies) might both be related to excessive/inflexible Enterprise Architecture (EA) governance and/or lack of business architecture process design & analysis automation capabilities. Understanding these root causes can help inform which capabilities to target for improvements.

FIG. 8 illustrates one embodiment of the invention that allows symptoms to be allocated to dimensions D, such that each Symptom Dimension Focus per Dimension D (SDF D)) is relevant (1) or not relevant (0). Then, each symptom gets its “share” of total symptom weight for this period (Swp) by adding up its allocated shares of activated speed, quality, and cost. Each additive share of symptom weight is calculated as:

$${S}_{{w}_{p}} = S D {F}_{S} * {S}_{S} + S D {F}_{Q} * {S}_{Q} + S D {F}_{C} * {S}_{C} \\ {S}_{{w}_{p}} = \frac{DF {W}_{{S}_{p}}}{{\sum }_{i = 1}^{n} SD {F}_{S}} + \frac{DF {W}_{{Q}_{p}}}{{\sum }_{i = 1}^{n} SD {F}_{Q}} + \frac{DF {W}_{{C}_{p}}}{{\sum }_{i = 1}^{n} SD {F}_{C}}$$

Where dimension focus weights for this period were determined in the previous step, and

$${\sum }_{i = 1}^{n} SD {F}_{D}$$

is the sum of all symptoms that a dimension D has been relevant for. For example, if a symptom category is “Estimation” and a symptom is “# of stories estimate >25% incorrect”, relevant dimensions are set as Speed and Cost (SDF_{S}=1, SDF_{Q}=0,SDF_{C}=1). The Dimension Focus Weight for Speed (DFW_{S}_{ₚ}) was previously set as 0.5, and Dimension Focus Weight for Cost (DFW_{C}_{ₚ}) was set as 0.17. Quality is not relevant for this symptom since it is switched off (SDF_{Q}=0). The total symptom weight is:

$${S}_{{w}_{p}} = \frac{0.5}{5} + 0 + \frac{0.17}{2} = 0.18$$

The symptom weight for period p (S_{w}_{ₚ}) is automatically calculated as shown above, but can be overridden subject to additional symptom weight override factors. Such factors are evaluated according to key data collection amplification considerations, suggesting higher or lower weights based on impact. Below is an example of symptom weight override factors:

| Symptom | | Higher weight | Lower weight |
|---|---|---|---|
| consideration | Description | for . . . | for . . . |
| Frequency | Frequency (how | Higher frequency | Lower frequency |
| | often the metric is | | metrics that need |
| | already available | | new collection |
| | for collection) | | efforts |
| Exposure | Exposure (# of | Higher # of people | Higher # of |
| | people involved) | involved. More | people to collect |
| | | people involved | information from |
| | | typically means | |
| | | more capability- | |
| | | investment impact | |
| Subj/Obj | Subjective vs. | Objective measures | Subjective |
| | Objective | are more defensible | measures are |
| | | | less defensible |
| Retrospective | Opportunities to | Higher retrospective | Low retrospective |
| maturity | quantitatively collect | maturity | maturity (e.g., |
| | data in already- | | not frequently |
| | existing retrospective | | happening) |
| | meetings? | | |

FIG. 9 exemplifies an embodiment of a planning matrix, which allows capability owners to make specific commitments to reducing blockage symptoms. Symptoms are listed alongside their Key Symptom Indicator (KSI) starting point. For example, “# days stuck in testing” at the start of this period is 20. In the example shown, specific objectives apply to one or more KSIs. The KSIs can be incrementally improved by implementing one or more objectives, where capability owners are incentivized to commit to “blockage reduction”—resulting in a target (lower) KSI. For example, the “# days stuck in testing” KSI is viewed in context of an objective “SAFe for Arch & Leading SAFe” training. The KSI is projected to be improved by 8 days as a result of lean-agile method improvements, reducing the target days stuck in testing to 12.

Development of improvement plans and objective targets includes consideration for capability investment. In accordance with the incentive-based model for capability owners to reduce blockage per symptom, those capability owners must be able to justify the investments needed to make the improvements.

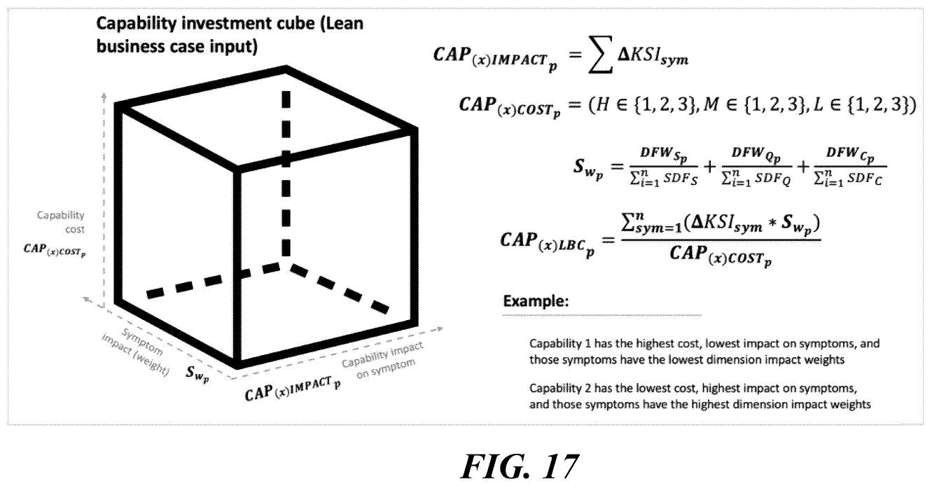

A typical approach to any type of initiative in a lean-agile portfolio management context is to use a Lean Business Case (LBC), and complete specification of an LBC is outside the scope of this invention. However, when developing an LBC for the purpose of “internal” Continuous Delivery Pipeline (CDP) improvement, the LBC can be tailored to accommodate a key input: a comparative analysis of capability investment decisions based on the “Capability investment cube”. As shown in FIG. 17, this calculation considers for capability impact on symptoms (CAP_{(x)IMPACT}_{ₚ}=ΣΔKSI_{sym}), the symptom impact weight (S_{w}_{ₚ}), and capability cost (CAP_{(x)COST}_{ₚ}). Then, a specific capability's lean business case input (CAP_{(x)LBC}_{ₚ}) is defined as:

$$CA {P}_{( x ) L B {C}_{p}} = \frac{{\sum }_{s y m = 1}^{n} ( Δ {KSI}_{s y m} * {S}_{{w}_{p}} )}{C A {P}_{( x ) {COST}_{p}}}$$

An example is shown FIG. 17 where a “Capability 1” in the top left corner of the cube is the worst choice for investment, and “Capability 2” is the best choice.

### Step 3: Build Data Collection Assets

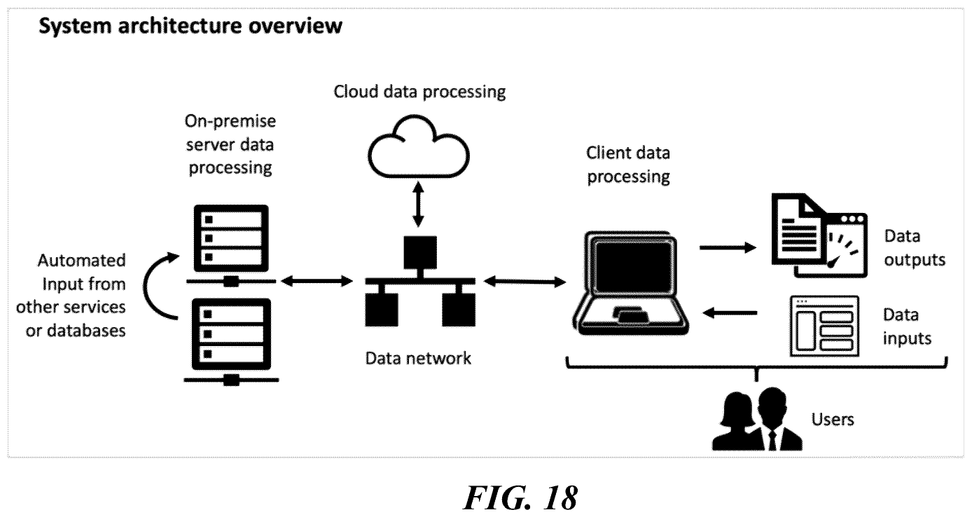

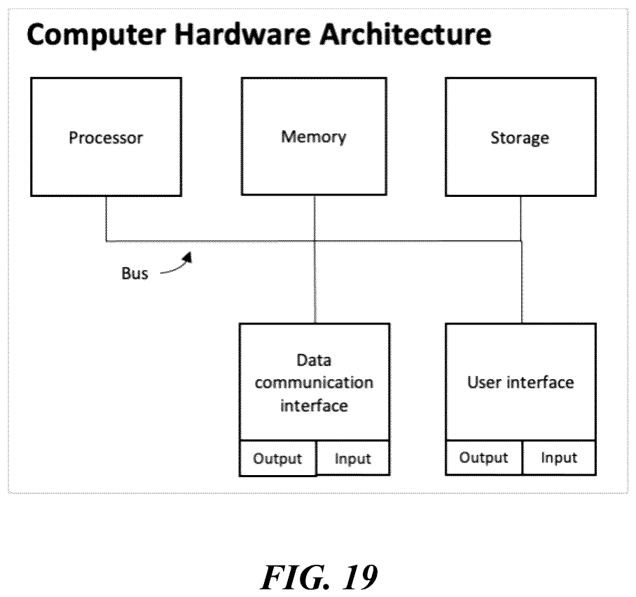

As Key Symptom Indicators (KSIs) are tailored, plans are developed to collect data. Data can be collected manually (e.g., collected via tabular spreadsheet and entered directly into a database or web application) or automatically (e.g., collected via API connected to data sources-such as a BPM/EA Solution Intent Repository or Agile Program Management application). System-related considerations for data collection are illustrated in FIG. 18 and FIG. 19.

### Step 4: Collect Data, Calculate & Visualize Real-Time Analytics

FIG. 10 illustrates an embodiment wherein data is retrieved in a defined scope (e.g., train, program, business unit) and period, and presented as it relates to a KSI Category and KSI. Metrics are collected in relevant contexts (for example, a Single Train may have Product A/Product B; a Program may display or collect data for one or more Trains). Data is aggregated for the scope and context selected as relevant in the example of FIG. 10, multiple trains are selected and the average KSI is made available for calculation and visualization of index scores. In another embodiment of the invention, capability-centric metrics are important to be tracked (e.g., “# of people trained”), and the User Interface will accommodate entry of such metrics in the appropriate capability context.

In regards to objective progress tracking, capability owners must be able to understand the outcomes of their capability implementation plans in real time. These are Key Symptom Indicators which are allocated to specific capabilities.

FIG. 11 shows an embodiment of the objective progress tracking user interface, where progress is tracked against planned improvement, in a defined scope and period and filtered against relevant dimensions (speed, quality, cost). A summary plan is presented per the scope and period, and a table of objective, target capabilities, and actual capabilities are listed. The actual objective achievement indicator is the average of KSI data collected from the relevant contexts (e.g., train 1 and train 2):

$$OB {J}_{x ( p )} = {\sum }_{ctx = 1}^{n} \frac{{KSI}_{c t x}}{n}$$

The target objective achievement score is defined as the sum of average target key symptom indicators, which would have been set at the end of last period, subtracting n target capability improvement targets cit.

$$O B {J}_{x ( t )} = {\sum }_{c i t = 1}^{n} {\overline{KSI}}_{( p - 1 )} - c i t$$

This is not weighted so capability owners can be accountable for their own KSI raw number movements. For example, in one embodiment of the interface shown in FIG. 10, the capability owner selects Objective view reporting. The average target KSI for this period for an example objective (e.g., “SAFe for Arch”) is spread across three symptoms and reporting by objective would add up that objective's share of Key Symptom Indicators.

The outcome of capability improvement efforts is more important than capability-centric measurements. However, in another embodiment of the invention, such capability-centric metrics can also be tracked (e.g., “# of people trained”). This would allow additional detail in capability effectiveness tracking, relating KSIs to capability-centric measurements (e.g., “# of people trained”: “#Inter-team dependency strings”), providing more timely feedback on “what's working” and “what isn't working”.

In contrast to objective progress tracking, blockage details do not report on capability improvement. Instead, they report normalized progress across all Key Symptom Indicators (KSIs), considering for the aggregated weight of importance for each symptom within a given time period (S_{w}_{ₚ}). As shown in FIG. 12, blockage details report a weighted blockage index for a given period (BI_{w}_{ₚ}) on a scale of (0% . . . 100%), where low blockage is favorable. The example user interface indicates a starting BI_{w}_{ₚ}, ending (actual) BI_{w}_{ₚ}, and a target BI_{tw}_{ₚ}. Each index requires the overall lower blockage target (KSIₜ) to indicate optimal blockage reduction and upper an blockage estimate (KSI_{b}), indicating “how bad it can get”.

$${KSI}_{t} = {min}_{x = M} ( F , x - x * {\overline{KSI}}_{p} )$$

There are two possible embodiments of the invention that define a target Key Symptom Indicator (KSI). The organization may set a fixed arbitrary floor F, indicating that it is not feasible to try improving a KSI below floor F. The organization may also set a floating multiplier M for the KSI, indicating that the floor is be some multiplier of the most recent K̅S̅I̅ₚ.

$${KSI}_{b} = {max}_{x = M} ( C , x * {\overline{KSI}}_{p} )$$

The worst blockage estimate is the inverse of KSIₜ, where a fixed ceiling C or multiplier M is set for the KSI. The weighted blockage index for a given period p BI_{w}_{ₚ} (FIG. 12 AND FIG. 13) is calculated as:

$${BI}_{{w}_{p}} = ( \frac{( {\overline{KSI}}_{p} - {KSI}_{t} )}{( {KSI}_{b} - {KSI}_{t} )} ) * {S}_{{w}_{p}}$$

This is the blocker index for this period (BI_{w}_{ₚ}), normalized from 0 (least blockage) to 1 (most blockage) and weighted with respect to the total symptom weight for this period S_{w}_{ₚ} (which accounts for potential allocations from speed, quality, and cost). The target blocker index for this period is a similar calculation, substituting the numerator K̅S̅I̅ₚ for K̅S̅I̅ₜₚ.

$${BI}_{t {w}_{p}} = ( \frac{( {\overline{KSI}}_{{t}_{p}} - {KSI}_{t} )}{( {KSI}_{b} - {KSI}_{t} )} ) * {S}_{{w}_{p}}$$

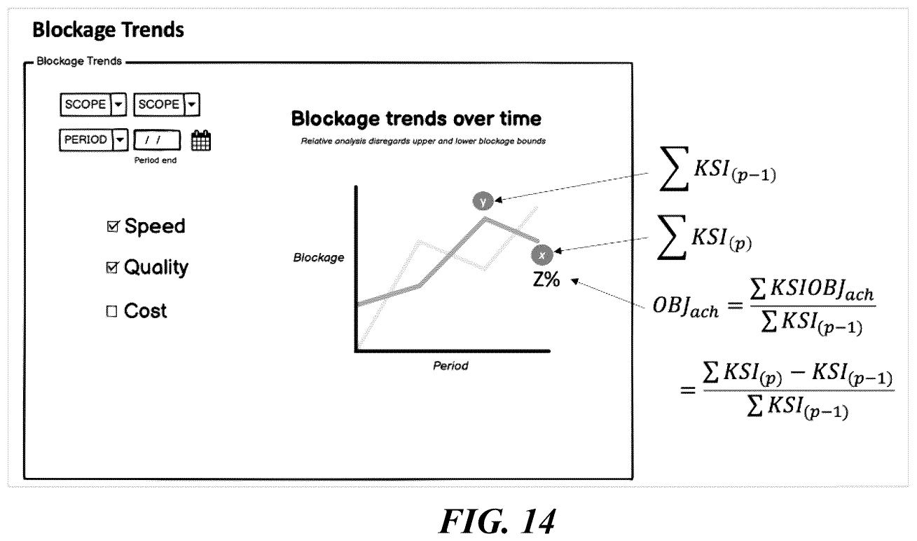

While KSI_{b} and KSIₜ will set the lower and upper bounds for the blockage index indicator, it is not worth investing excessive time determining these, since absolute change can be measured using blockage trends over time (see FIG. 14):

$${OBJ}_{a c h} = \frac{\sum ( {KSI}_{( p )} - {KSI}_{( p - 1 )} )}{\sum {KSI}_{( p - 1 )}}$$

For example, if period 1 has a total summation of blockage points 597 (KSI₍ₚ₋₁₎) and period 2 has 516 points (KSI₍ₚ₎), this shows a 13.5% improvement of blockage on an absolute (unweighted) KSI basis.

### Step 5: Report Blockage Index Scores & Improvement Progress

Various executive reporting dashboard examples of the invention accommodate high-level reporting and improvement progress tracking. In reference to FIG. 13, an example visualization of blockage improvement shows start, target (for the period), and actual blockage. The relevant calculations (BI_{w}_{₍ₚ₋₁₎}, BI_{tw}_{ₚ}, BI_{w}_{ₚ}) are the same as those shown in FIG. 12. These are aggregated to the selected scope (e.g., shown in FIG. 6) within the selected period and filtered by speed, quality, and/or cost.

FIG. 14 shows trend blockage over time. In contrast to the overall blockage improvement report in FIG. 13, the blockage trendline does not require either a Key Symptom Indicator (KSI) “worst” upper value (KSI_{b}) or a “target” lowest value (KSIₜ) to show progress across periods. This acknowledges that the organization may “move the goalposts” on occasion and need a purely comparative analysis basis to measure blockage progress.

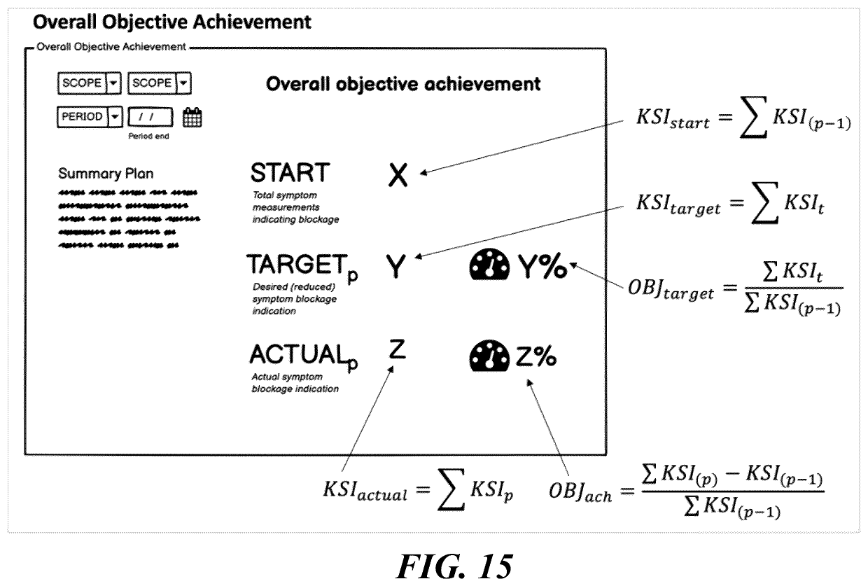

FIG. 15 shows an example objective achievement dashboard, within a specific scope and period. This view shows the absolute (non-weighted) values for KSI start, KSI target, and KSI actual achievement. The target (OBJ_{target}) is exemplified using “speedometer” and/or percentage representation, where the desired improvement is:

$${OBJ}_{t a r g e t} = \frac{\sum {KSI}_{t}}{\sum {KSI}_{( p - 1 )}}$$

For example, if the sum of all capabilities expected to result in a KSI target of 529, and the previous KSI is 597, the expected improvement from objective implementation is 13.5%. The actual objective achievement is:

$${OBJ}_{a c h} = \frac{\sum ( {KSI}_{( p )} - {KSI}_{( p - 1 )} )}{\sum {KSI}_{( p - 1 )}}$$

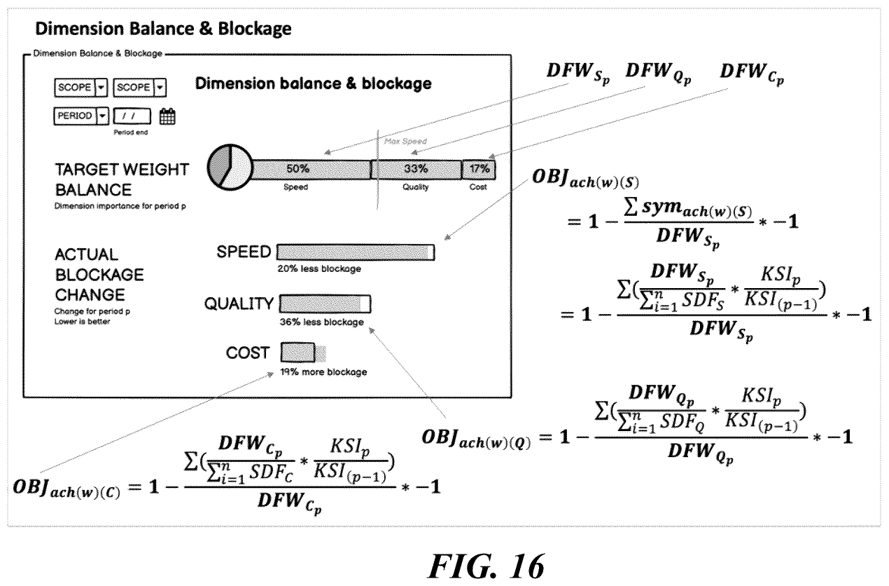

FIG. 16 illustrates an embodiment which allows executives, capability owners, and project/product managers to visualize improvements against weighted targets per dimension (speed, quality, cost). The shows the target weight balance for period p that was set in step one, as shown FIG. 5. The dimension focus weight for speed (DFW_{S}_{ₚ}), quality (DFW_{Q}_{ₚ}), and cost (DFW_{C}_{ₚ}) are shown, with an indicator shown to demarcate the maximum speed-Agile Speed Limit (ASL). This is one representation of the data, and others (such as pie charts) may be used to represent the dimension balance information.

Shown in context of the target weight balance are the actual blockage changes, per dimension. The three dimensions represented are speed (OBJ_{ach(w)(S)}), quality (OBJ_{ach(w)(Q)}), and cost (OBJ_{ach(w)(C)}). The representation of the separate dimensions allow actual objective improvement visualization, in context of weighted importance. All three objective formulas follow the same form, substituting for dimension. The weighted speed objective accomplishment is calculated as follows:

$${OBJ}_{a c h ( w ) ( S )} = 1 - \frac{\sum sy {m}_{a c h ( w ) ( S )}}{{DFW}_{{S}_{p}}} * - 1 = 1 - \frac{\sum ( \frac{{DFW}_{{S}_{p}}}{{\sum }_{t = 1}^{n} {SDF}_{S}} * \frac{{KSI}_{p}}{{KSI}_{( p - 1 )}} )}{{DFW}_{{S}_{p}}} * - 1$$

For example, consider a scenario where the dimension focus weight for speed (DFW_{S}_{ₚ}=0.50 (50%), and there has been a 20% favorable decrease in blockage attributable to speed (that is, speed now has 20% less blockage). Each symptom that went towards speed improvement (sym_{ach(w)(S)}) had a weighted impact (DFW_{S}_{ₚ}). Each of those symptoms saw some change (better or worse) evidenced by the proportion of KSI improvement over last period (KSIₚ/KSI₍ₚ₋₁₎). In this example, there are seven such symptoms that add up to sym_{ach(w)(S)}= 0.40. The percentage of blockage change is found when dividing 0.40 by 0.50, resulting in a blockage change of −20%.

### System Architecture

A computer-automated embodiment of the invention (including but not limited to process, formulas/calculations and associated user interface inputs/outputs) can be realized in through the use of computer hardware as shown in FIG. 19. A computer processor, memory, and storage process data that is input/output via a data communication interface (e.g., between other computer systems/Application Programing Interfaces) or a user interface, receiving input from and providing output to human operators.

FIG. 18 shows a possible system architecture context for a computer-automated embodiment of the invention, where data is processed by on-premise or cloud computer hardware. The invention's components operate in the context of a “back-end” for receiving, processing, and sending data. Data is exchanged between the back-end and front-end to users, who use endpoint computer hardware (e.g., laptops, desktops, mobile devices) to receive data inputs and display data outputs (e.g., reports and dashboards).

Processors suitable for the execution of computer readable program instructions include both general and special purpose microprocessors and any one or more processors of any digital computing device. For example, each processor may be a single processing unit or a number of processing units and may include single or multiple computing units or multiple processing cores. The processor(s) can be implemented as one or more microprocessors, microcomputers, microcontrollers, digital signal processors, central processing units, state machines, logic circuitries, and/or any devices that manipulate signals based on operational instructions. For example, the processor(s) may be one or more hardware processors and/or logic circuits of any suitable type specifically programmed or configured to execute the algorithms and processes described herein. The processor(s) can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Data can also be directly input/output from/to other computers (e.g., via API's to/from other applications or databases). In this way, the back-end components can automatically receive data from systems of record that accelerate and automate the input of metrics needed to populate Key Symptom Indicators (KSIs). For example, a project/agile management application can automatically record and report metrics that can furnish data for a Key Symptom Indicator (such as the number of dependencies between teams and system architects).

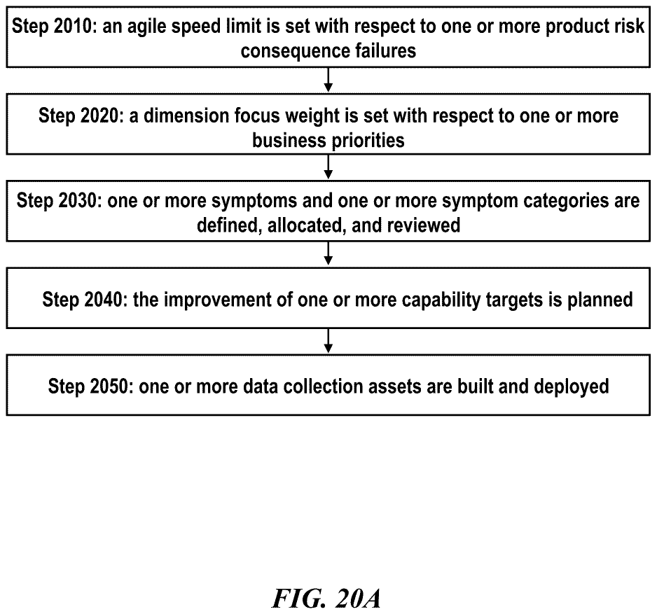

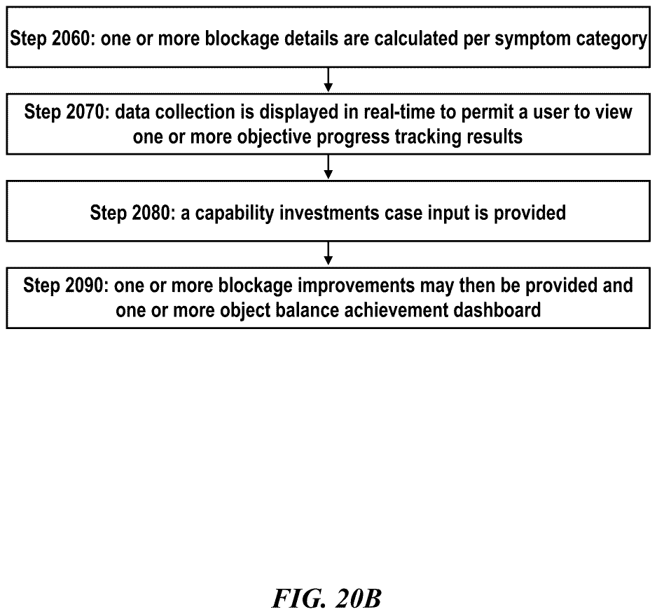

FIG. 20 illustrates a flowchart for a method of reducing digital product lifecycle agility blockage across speed, quality, and cost. In step 2010 an agile speed limit is set with respect to one or more product risk consequence failures. In step 2020, a dimension focus weight is set with respect to one or more business priorities. In step 2030, one or more symptoms and one or more symptom categories are defined, allocated, and reviewed. In step 2040, the improvement of one or more capability targets is planned and one or more data collection assets are built and deployed in step 2050. In step 2060, one or more blockage details are calculated per symptom category. In step 2070, data collection is displayed in real-time to permit a user to view one or more objective progress tracking results and a capability investments case input is provided in step 2080. In step 2090, one or more blockage improvements may then be provided and one or more object balance achievement dashboard.

The disclosed system and method introduce an advanced framework for agility optimization in digital product lifecycle management. The following steps illustrate the comprehensive approach of the invention:

Setting an Agile Speed Limit: The system computes an adaptive agile speed limit based on historical failure probabilities, real-time performance metrics, and external risk factors.

Applying Adaptive Dimension Focus Weights: The system dynamically adjusts agility dimensions (speed, quality, and cost) in response to shifting business priorities, external market conditions, and real-time operational performance.

Identifying and Categorizing Agility Symptoms: AI-based clustering algorithms classify symptoms into technical, operational, and financial categories, providing an intelligent framework for root-cause analysis.

Implementing Targeted Capability Improvements: AI-powered recommendation engines prescribe capability improvements based on data-driven insights, optimizing investment allocation for maximum impact.

Deploying Automated Real-Time Data Collection: The system continuously captures and analyzes agility-related metrics through enterprise application integrations, reducing manual intervention.

Computing Blockage Metrics Using Weighted Severity Index: A weighted severity index calculates the impact of agility blockages based on symptom severity, frequency, and recurrence trends.

Providing Real-Time Objective Tracking Results: The system generates real-time analytics and visualizations, displaying agility improvements in customizable dashboards tailored to different user roles.

Generating AI-Powered Investment Recommendations: An AI-driven decision-support engine generates investment case inputs based on historical performance trends, benchmarking data, and predictive modeling.

Visualizing Agility Improvements Dynamically: Multi-user dashboards present real-time insights into agility trends, providing executives, project managers, and stakeholders with an intuitive interface for informed decision-making.

The system architecture comprises a processor, a real-time tracking module, a data storage component, an AI-powered recommendation engine, and a visualization interface. The tracking module continuously refines agility analytics using reinforcement learning, while the decision-support engine suggests optimal investment allocations based on scenario-based forecasting models.

The non-transitory computer-readable storage medium contains machine learning models that facilitate real-time agility optimization. The stored instructions enable continuous assessment of agility performance and automate the refinement of investment strategies. The system integrates seamlessly with enterprise portfolio management tools, cloud-based analytics platforms, and industry benchmarking databases.

By employing AI-based clustering, reinforcement learning, and predictive analytics, the disclosed invention surpasses traditional agility management approaches. The combination of real-time tracking, automated investment case generation, and adaptive agility weight adjustments ensures continuous optimization of digital product development cycles.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A method for optimizing digital product lifecycle agility by dynamically reducing blockages, implemented on a non-transitory computer system having one or more processors, memory, and a client-server architecture that ingests objective and quantifiable operational telemetry and Key Symptom Indicator (KSI) metric data from external development and portfolio tools via API-coupled data-collection assets, the method comprising the steps of:
establishing an agile speed limit (ASL) based on calculated product risk consequences by computing a risk-prioritized minimum quality guardrail using FMEA-based risk priority numbers (RPN=Severity×OccurrencexDetection) to derive an Agile Speed Limit for Speed-Quality (ASLSQ) and Speed-Quality-Cost (ASLSQC);
applying adaptive dimension focus weights (DFW) for speed, quality, and cost using the disclosed DFW formulas aligned with business priorities, including validating that the dimension focus weights sum to 100% and are validated against minimum-quality and maximum-speed guardrails;
identifying and categorizing agility symptoms based on real-time data allocated per dimension using disclosed symptom-allocation equations, wherein each symptom is allocated to one or more of speed, quality, or cost for a selected period and is assigned a symptom weight derived from the dimension focus weights;
implementing targeted capability improvements selected from a capability investment cube that trades off capability impact and cost computed from KSI improvements derived from machine learning analysis, wherein the capability investment cube computes a comparative capability investment case input based on capability impact on symptoms, symptom impact weight, and capability cost;
deploying automated real-time data collection assets via tailored KSI applications and integrations to ALM/DevOps and portfolio systems, including retrieving KSI metric data automatically via API connection to one or more data sources within a selected scope and period;
computing blockage metrics using a weight severity index including KSI-based worst and target blockage indices for each symptom category and a weighted blocker index B_w for a selected period, including normalizing the computed blocker index to a bounded scale from 0 (least blockage) to 1 (most blockage) and weighting the blocker index by the total symptom weight for the selected period;
providing real-time objective tracking results via an analytics engine that computes objective achievement OB_{avg} for a scope and period from collected KSI values, including presenting an objective progress tracking user interface in real time to permit capability owners to view progress against planned improvement within the selected scope and period and filtered by one or more of speed, quality, or cost;
generating investment case recommendations based on predictive modeling that the system applies to update capability investment plans in the portfolio context; and
visualizing agility improvements dynamically in a multi-user dashboard that presents ASL guardrails, DFW target/actual, OB, and B_w trends and that constrains throughput according to the computed ASL guardrail, including displaying role-friendly dashboard visualizations that communicate blockage improvement and objective balance achievement across speed, quality, and cost over discrete time periods.

2. The method of claim 1, wherein the agile speed limit is determined using real-time failure probability modeling based on historical product data.

3. The method of claim 1, wherein adaptive dimension focus weights account for dynamic shifts in organizational priorities and external market conditions.

4. The method of claim 1, wherein categorized agility symptoms are automatically classified into operational, financial, and technical domains using AI-based clustering algorithms.

5. The method of claim 1, wherein blockage metrics are computed using weighted severity factors derived from enterprise-level operational data.

6. The method of claim 1, wherein real-time tracking results incorporate machine learning predictions for forward-looking agility assessments.

7. The method of claim 1, wherein investment case recommendations are generated dynamically based on real-time performance deviations.

8. The method of claim 1, wherein a deep-learning-based root-cause analysis framework identifies and prioritizes symptom dependencies.

9. The method of claim 1, wherein agility blockages are dynamically ranked based on severity, frequency, and organizational impact.

10. The method of claim 1, wherein agility blockage reduction outcomes are benchmarked against industry-specific agility performance baselines.

11. The method of claim 1, wherein dynamically generated agility improvement reports facilitate regulatory compliance and auditing.

12. A system for managing digital product lifecycle agility blockage, the system comprising a non-transitory computer system having one or more processors, memory, and a client-server architecture that ingests objective and quantifiable operational telemetry and Key Symptom Indicator (KSI) metric data from external development and portfolio tools via API-coupled data-collection assets, the system further comprising:
a processor configured to compute an adaptive agile speed limit based on multi-factor risk assessment by executing FMEA-based RPN computations and deriving ASLSQ/ASLSQC guardrails for the period, including validating that dimension focus weights sum to 100% and are validated against minimum-quality and maximum-speed guardrails;
a data storage component configured to log real-time agility metrics and business priorities including KSI values, ASL parameters, DFW targets and actuals, OB, and B_{w,p}, wherein the KSI metric data is automatically retrieved via API connection to one or more data sources within a selected scope and period;
a predictive tracking module for analyzing agility symptoms and implementing optimized capability adjustments using the capability investment cube and portfolio plan updates, wherein each symptom is allocated to one or more of speed, quality, or cost for a selected period and is assigned a symptom weight derived from the dimension focus weights, and wherein the capability investment cube computes a comparative capability investment case input based on capability impact on symptoms, symptom impact weight, and capability cost;
a visualization interface with real-time analytics and stakeholder-customizable views rendering executive, program, and capability-owner dashboards that display computed equations, including presenting an objective progress tracking user interface in real time to permit capability owners to view progress against planned improvement within the selected scope and period and filtered by one or more of speed, quality, or cost, and including displaying role-friendly dashboard visualizations that communicate blockage improvement and objective balance achievement across speed, quality, and cost over discrete time periods; and
a decision support engine utilizing AI-driven recommendations for strategic investment allocations that are written back to portfolio tools via APIs, wherein the computed blocker index is normalized to a bounded scale from 0 (least blockage) to 1 (most blockage) and is weighted by the total symptom weight for the selected period, and wherein the visualization interface constrains throughput according to the computed ASL guardrail.

13. The system of claim 12, wherein the predictive tracking module continuously refines agility blockage analytics through reinforcement learning techniques.

14. The system of claim 12, wherein the visualization interface includes customizable real-time dashboards tailored to individual user roles.

15. The system of claim 12, wherein the decision-support engine integrates with enterprise portfolio management tools for optimized investment planning.

16. The system of claim 12, wherein agility improvement plans are dynamically updated based on changing blockage trend analyses.

17. The method of claim 12, wherein an AI-powered recommendation engine provides scenario-based capability investment forecasts.

18. A non-transitory computer readable storage medium storing instructions that, when executed by a processor, cause the processor to perform a method for optimizing digital product lifecycle agility blockage reduction, within the client-server architecture with API-coupled data-collection assets that ingest objective and quantifiable operational telemetry and Key Symptom Indicator (KSI) metric data from external development and portfolio tools, the method comprising:
establishing an agile speed limit based on calculated product risk consequences using FMEA-derived ASLSQ/ASLSQC, including computing a risk-prioritized minimum quality guardrail using FMEA-based risk priority numbers (RPN=SeverityxOccurrencexDetection);
applying adaptive dimension focus weights aligned with business priorities using the DFW equations and guardrails, including validating that the dimension focus weights sum to 100% and are validated against minimum-quality and maximum-speed guardrails;
identifying and categorizing agility symptoms based on real-time data and allocating symptoms to dimensions per FIG. 8 equations, wherein each symptom is allocated to one or more of speed, quality, or cost for a selected period and is assigned a symptom weight derived from the dimension focus weights;
implementing targeted capability improvements selected via the capability investment cube from computed KSI impacts and capability costs derived from machine learning analysis, wherein the capability investment cube computes a comparative capability investment case input based on capability impact on symptoms, symptom impact weight, and capability cost;
deploying automated real-time data collection assets integrated to DevOps/portfolio tools via APIs, including retrieving KSI metric data automatically via API connection to one or more data sources within a selected scope and period;
computing blockage metrics using a weight severity index by computing KSI_w, KSI_tgt, and B_{w,p}, including normalizing the computed blocker index to a bounded scale from 0 (least blockage) to 1 (most blockage) and weighting the blocker index by the total symptom weight for the selected period;
providing real-time objective tracking results via an analytics engine that computes OB_{avg} and OB_{tgt}, including presenting an objective progress tracking user interface in real time to permit capability owners to view progress against planned improvement within the selected scope and period and filtered by one or more of speed, quality, or cost;
generating investment case recommendations based on predictive modeling and applying the recommendations to update portfolio plans; and
visualizing agility improvements dynamically in a multi-user dashboard that enforces the ASL guardrail for throughput, including displaying role-friendly dashboard visualizations that communicate blockage improvement and objective balance achievement across speed, quality, and cost over discrete time periods.

19. The method of claim 18, wherein capability improvements are suggested using a neural network-based recommendation system.

20. The method of claim 18, wherein real-time tracking results are accessible through a cloud-based data visualization platform.
